(19) United States
(12) Patent Application Publication
(10) Pub. No.: US 2004/0178368 A1
(43) Pub. Date: Sep. 16, 2004

(54) UV curing module for label printer

(76) Inventors: Kevin Girard Conwell, Fairfield, OH (US); Matt Adams, Cincinnati, OH (US)

Correspondence Address: ORUM & ROTH, 53 W. JACKSON BLVD, CHICAGO, IL, 60604, US

(21) Appl. No.: 10/811,732

(22) Filed: Mar. 29, 2004

Related U.S. Application Data
(62) Division of application No. 10/120,620, filed on Apr. 11, 2002, now Pat. No. 6,732,451.
(60) Provisional application No. 60/287,842, filed on May 1, 2001.
(60) Provisional application No. 60/283,113, filed on Apr. 11, 2001.

(51) Int. Cl. G01J 1/00

(52) U.S. Cl. 250/504 R; 34/275

(57) ABSTRACT

A UV curing module for use with a label printer. UV curing lamps/radiation sensors are located to cover the label media path. The UV curing module may be integrated into the label printer or similar devices including a label applicator or a label rewinder.

This application claims the benefit of U.S. Provisional Application No. 60/287,842 filed May 1, 2001 and U.S. Provisional Application No. 60/283,113 filed Apr. 11, 2001.

### BACKGROUND OF THE INVENTION

1. Field of the Invention

The invention relates generally to a UV curing device for use with a label printer and is specifically directed to a label applicator or label rewinder with integrated ultraviolet (UV) curing functionality.

2. Description of the Related Art

UV curing of printed images is normally associated with gravure, offset, screen or flexo-graphic printing processes and equipment.

The inventors are unaware of the previous application of integrated UV curing capability with a label applicator.

On demand printing, unlike the previous above listed printing processes provides a custom label or rolls of, for example, sequentially numbered labels on demand. With the capability of printing near or at the point of use, on demand printers are often used to provide unique labels for application in high abrasion and or chemical environments, for example in the engine compartment of automobiles. Some previous on demand printers for these applications have used protective over coverings and or labels having a layered structure. These solutions have added media and machine complexity and overall increased materials costs.

UV curable links are cured by exposure to UV light. The UV light initiates photo polymerization causing the ink's chemical conversion to a cross-linked polymer. Compared to conventional inks, UV curable inks create an image with improved abrasion and chemical resistance characteristics.

UV curable inks, UV curing apparatus, light guides, reflectors/concentrators for UV light, and label applicators are disclosed in detail in the following references hereby incorporated by reference: U.S. Pat. No. 4,483,585 “Illuminating device having optical light guide formed as fibre bundle”

U.S. Pat. No. 4,924,599 “UV curing apparatus”

U.S. Pat. No. 5,832,362 “Apparatus for generating parallel radiation for curing photosensitive resin”

U.S. Pat. No. 4,052,280 “UV curing of polymerizable binders”

U.S. Pat. No. 5,521,392 “Light cure system with closed loop control and work piece recording”

U.S. Pat. No. 5,905,012 “Radiation curable toner particles”

### BRIEF DESCRIPTION OF THE FIGURES

FIG. 1 is a schematic of a label applicator embodiment of the invention.

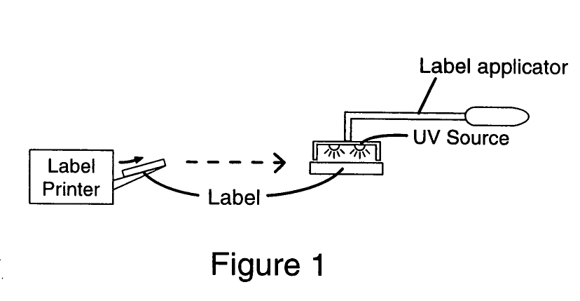

FIG. 2 id a schematic of a label rewinder embodiment of the invention.

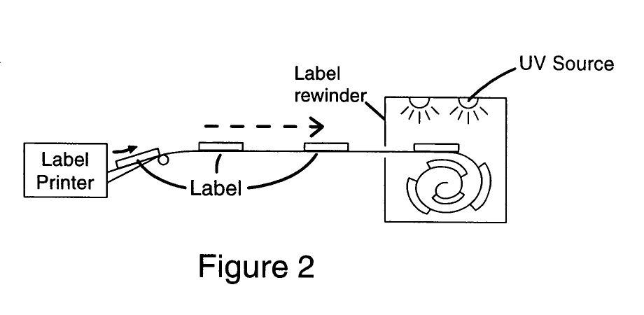

### DETAILED DESCRIPTION

A label applicator or rewinder unit is modified to include a UV curing device. In a label applicator embodiment, the UV curing element may be built into the head which picks up a label or it may be mounted over a belt drive that carries/transports the label from the printer to the applicator head. In a label rewinder embodiment, the UV curing element may be built into the rewinder enclosure or it may be mounted over a belt drive that carries/transports the label from the printer to the label rewinder. The UV energy from the UV curing device is focused upon the printed image such that the ink chemistry cures under UV radiation into a cross linked polymer.

The UV curing system or module would be user adjustable to match the light source wavelength to activate photo initiators in the ink chemistry.

The UV curing unit/module may be integrated into the on-demand label printer, applied to a stand alone off-line applicator unit for example designed to handle rolls of pre-printed labels, or it may be applied to a stand alone off-line label rewinder unit for example designed to rewind labels onto rolls of pre-printed labels as they exit the printer.

A label applicator or rewinder with a UV curing module may be either factory installed in new applicator or rewinder equipment or used installed as an add-on accessory. The lamp and/or power source may be positioned directly over the label path providing light energy focused on the label image as it passes or the lamp/power source may be located remote from the immediate path and the light energy directed from the lamp/power source through a fiber optic cable. Cooling of the UV lamp chamber may be via forced high-velocity air. The UV lamp and/or chamber may be equipped with a UV filter/shield to minimize or eliminate user exposure to the light energy. The light/power source of the unit may be selectable between different lamps and/or filters for the lamps to match the wavelength and light energy to the photo initiator chemistry in the inks. The lamp/energy power source may be a pulsed xenon flash lamp with the wavelength optimized by a circuit which allows for shifting current density.

Feedback to manipulate the lamp/power source output may be provided by a photo sensor control circuit depending upon the type of lamp/power source the photo sensor may be, for example, a fluorescent active optical sensor or a filtered photodiode sensor. The UV curing component may include a typical angled or parabolic curved reflector of metallic or dichromic material which may allow the adjustment of a focal point and intensity of the light energy. The lamp may be quartz, mercury vapor or other inert gas device. Lamp excitation may be through a conventional arc, radio frequency or microwave energy. Lamp and/or power source initiation may be by a label sensor or printer signal.

The integration of the UV curing function into the label applicator or rewinder allows the use of the device with the wide range of existing thermal transfer printers capable of using ultraviolet thermal transfer ribbons without adaptation or conversion (including additional hardware or software adjustments). In other embodiments the label applicator may also utilize other on demand printers such as inkjets, dot matrix, impact, or laser systems which are capable of utilizing inks which are photo polymerizable to a more durable state. The wide applicability of UV curing capability in an applicator allows the option of using UV curable print media without requiring a large capital investment.

We claim:

1) A UV curing module comprising:
means for curing UV curable ink arranged above a media flow path.

2) The UV curing module of claim 1, wherein the means for curing is a module attached to a label rewinder.

3) The UV curing module of claim 1, wherein the means for curing is a module attached to a label applicator.
